(19) United States
(12) Patent Application Publication
(10) Pub. No.: US 2014/0241930 A1
(43) Pub. Date: Aug. 28, 2014

(54) PERMANENT MAGNET AND METHOD FOR MANUFACTURING PERMANENT MAGNET

(71) Applicants: Tomohiro Omure, Ibaraki-shi (JP); Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Keisuke Taihaku, Ibaraki-shi (JP); Takashi Yamamoto, Ibaraki-shi (JP)

(72) Inventors: Tomohiro Omure, Ibaraki-shi (JP); Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Keisuke Taihaku, Ibaraki-shi (JP); Takashi Yamamoto, Ibaraki-shi (JP)

(73) Assignee: NITTO DENKO CORPORATION, Ibaraki-shi, Osaka (JP)

(21) Appl. No.: 14/241,586

(22) PCT Filed: Sep. 25, 2012
(86) PCT No.: PCT/JP2012/074474

§ 371 Date: Feb. 27, 2014

(30) Foreign Application Priority Data
Sep. 30, 2011 (JP) 2011-218601

(51) Int. Cl. H01F 41/02

(52) U.S. Cl. CPC H01F 41/0266
USPC 419/33

(57) ABSTRACT

There are provided a permanent magnet and a manufacturing method thereof enabling, even when wet milling is employed, carbon content contained in magnet particles to be reduced in advance before sintering, and also enabling the entirety of the magnet to be densely sintered without causing a gap between a main phase and a grain boundary phase in the sintered magnet. Coarsely-milled magnet powder is further milled by a bead mill in an organic solvent. Thereafter, the magnet powder is compacted to produce a formed body. Hydrogen calcination process is performed through holding the formed body for several hours in hydrogen atmosphere at a pressure higher than normal atmospheric pressure at 200 through 900 degrees Celsius. Thereafter, through sintering process, a permanent magnet 1 is manufactured.

### TECHNICAL FIELD

The present invention relates to a permanent magnet and a manufacturing method of the permanent magnet.

### BACKGROUND ART

In recent years, a decrease in size and weight, an increase in power output and an increase in efficiency have been demanded in a permanent magnet motor used in a hybrid car, a hard disk drive, or the like. A further improvement in magnetic performance is required of a permanent magnet to be buried in the permanent magnet motor, for the purpose of realizing such a decrease in size and weight, an increase in power output and an increase in efficiency in the permanent magnet motor mentioned above. Meanwhile, as permanent magnet, there have been known ferrite magnets, Sm—Co-based magnets, Nd—Fe—B-based magnets, Sm₂Fe₁₇Nₓ-based magnets or the like. As permanent magnet for permanent magnet motor, Nd—Fe—B-based magnets are typically used among them due to their remarkably high residual magnetic flux density.

As method for manufacturing a permanent magnet, a powder sintering process is generally used. In this powder sintering process, raw material is coarsely milled first and furthermore, is finely milled into magnet powder by a jet mill (dry-milling) method or a wet bead mill (wet-milling) method. Thereafter, the magnet powder is put in a mold and pressed to form in a desired shape with magnetic field applied from outside. Then, the magnet powder formed and solidified in the desired shape is sintered at a predetermined temperature (for instance, at a temperature between 800 and 1150 degrees Celsius for the case of Nd—Fe—B-based magnet) for completion.

### PRIOR ART DOCUMENT

### Patent Document

Patent document 1: Japanese Registered Patent Publication No. 3298219 (pages 4 and 5)

### DISCLOSURE OF THE INVENTION

### Problem to be Solved by the Invention

It has been known that basically the magnetic performance of a permanent magnet can be improved by making the crystal grain size in a sintered body very fine, because the magnetic characteristics of a magnet can be approximated by a theory of single-domain particles. Here, in order to make the grain size in the sintered body very fine, a particle size of the magnet raw material before sintering also needs to be made very fine.

Here, the milling methods to be employed at the milling of the magnet raw material include wet bead milling, in which a container is rotated with beads (media) put therein, and slurry of the raw material mixed in a solvent is added into the container, so that the raw material is ground and milled. The wet bead milling allows the magnet raw material to be milled into a range of fine particle size (for instance, 0.1 μm through 5.0 μm).

However, in a wet milling method like the above wet bead milling, an organic solvent such as toluene, cyclohexane, ethyl acetate and methanol may be used as a solvent to be mixed with the magnet raw material. Accordingly, even if the organic solvent is volatilized through vacuum desiccation or the like after milling, carbon-containing material may remain in the magnet. Then, reactivity of neodymium (Nd) and carbon is significantly high and carbide is formed in case carbon-containing material remains even at a high-temperature stage in a sintering process. Consequently, there has been such a problem as thus formed carbide causes a gap between a main phase and a grain boundary phase, so that the entirety of the magnet cannot be sintered densely, drastically degrading magnetic performance thereof. Even if no gap is formed, there still be a problem that the formed carbide causes alpha iron to separate out in a main phase of a sintered magnet and magnetic properties are considerably degraded.

The invention has been made in order to solve the above-mentioned conventional problems, and an object of the invention is to provide a permanent magnet in which the magnet powder mixed with the organic solvent at the wet milling is calcined in a hydrogen atmosphere at a pressure higher than normal atmospheric pressure before sintering, so that the amount of carbon contained in a magnet particle can be reduced in advance, enabling the entirety of the magnet to be densely sintered without making a gap between a main phase and a grain boundary phase in the sintered magnet.

### Means for Solving the Problem

To achieve the above object, the present invention provides a permanent magnet manufactured through steps of: wet-milling magnet material in an organic solvent to obtain magnet powder; forming the magnet powder into a formed body; calcining the formed body in hydrogen atmosphere at a pressure higher than normal atmospheric pressure so as to obtain a calcined body; and sintering the calcined body.

To achieve the above object, the present invention further provides a permanent magnet manufactured through steps of, wet-milling magnet material in an organic solvent to obtain magnet powder; calcining the magnet powder in hydrogen atmosphere at a pressure higher than normal atmospheric pressure so as to obtain calcined powder; forming the calcined powder into a formed body; and sintering the formed body.

In the above-described permanent magnet of the present invention, in the step of calcining the formed body, the formed body is held for predetermined length of time within a temperature range between 200 and 900 degrees Celsius.

In the above-described permanent magnet of the present invention, in the step of calcining the magnet powder, the magnet powder is held for predetermined length of time within a temperature range between 200 and 900 degrees Celsius.

In the above-described permanent magnet of the present invention, residual carbon content after sintering is 400 ppm or lower.

To achieve the above object, the present invention further provides a manufacturing method of a permanent magnet comprising steps of wet-milling magnet material in an organic solvent to obtain magnet powder; forming the magnet powder into a formed body; calcining the formed body in hydrogen atmosphere at a pressure higher than normal atmospheric pressure so as to obtain a calcined body; and sintering the calcined body.

To achieve the above object, the present invention further provides a manufacturing method of a permanent magnet comprising steps of wet-milling magnet material in an organic solvent to obtain magnet powder; calcining the magnet powder in hydrogen atmosphere at a pressure higher than normal atmospheric pressure so as to obtain calcined powder; forming the calcined powder into a formed body; and sintering the formed body.

In the above-described manufacturing method of permanent magnet of the present invention, in the step of calcining the formed body, the formed body is held for predetermined length of time within a temperature range between 200 and 900 degrees Celsius.

In the above-described manufacturing method of permanent magnet of the present invention, in the step of calcining the magnet powder, the magnet powder is held for predetermined length of time within a temperature range between 200 and 900 degrees Celsius.

### Effect of the Invention

According to the permanent magnet of the present invention having the above configuration, a formed body of magnet powder mixed with the organic solvent at the wet milling in the manufacturing process of the permanent magnet is calcined in a hydrogen atmosphere at a pressure higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable alpha iron does not separate out in the main phase of the sintered magnet and serious deterioration of magnetic properties can be avoided.

Furthermore, according to the permanent magnet of the present invention, magnet powder mixed with an organic solvent at the wet milling in the manufacturing processes of the permanent magnet is calcined in a hydrogen atmosphere at a pressure higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable alpha iron does not separate out in the main phase of the sintered magnet and serious deterioration of magnetic properties can be avoided.

Further, since powdery magnet particles are calcined, thermal decomposition of the organic compound can be caused more easily in the entirety of the magnet particles in comparison with the case of calcining a formed body of magnet particles. In other words, carbon content in the calcined powder can be reduced more reliably.

According to the permanent magnet of the present invention, in the step of calcining the formed body, the magnet powder is held for predetermined length of time within a temperature range between 200 and 900 degrees Celsius. Therefore, thermal decomposition of the organic compound can be caused reliably and carbon contained in the formed body can be removed more than required.

According to the permanent magnet of the present invention, in the step of calcining the magnet powder, the magnet powder is held for predetermined length of time within a temperature range between 200 and 900 degrees Celsius. Therefore, thermal decomposition of the organic compound can be caused reliably and carbon contained in the magnet powder can be removed more than required.

According to the permanent magnet of the present invention, the residual carbon content after sintering is 400 ppm or lower. This configuration avoids occurrence of a gap between a main phase and a grain boundary phase, places the entirety of the magnet in densely-sintered state and makes it possible to avoid decline in residual magnetic flux density. Further, this configuration prevents considerable alpha iron from separating out in the main phase of the sintered magnet so that serious deterioration of magnetic properties can be avoided.

According to the manufacturing method of a permanent magnet of the present invention, a formed body of magnet powder mixed with organic solvent at the wet milling is calcined in a hydrogen atmosphere at a pressure higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

According to the manufacturing method of a permanent magnet of the present invention, magnet powder mixed with an organic solvent at the wet milling in the manufacturing processes of the permanent magnet is calcined in a hydrogen atmosphere at a pressure higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Further, since powdery magnet particles are calcined, thermal decomposition of the organic compound can be caused more easily in the entirety of the magnet particles in comparison with the case of calcining magnet particles already molded into a shape. In other words, carbon content in the calcined powder can be reduced more reliably.

According to the manufacturing method of a permanent magnet of the present invention, in the step of calcining the magnet powder, the formed body is held for predetermined length of time within a temperature range between 200 and 900 degrees Celsius. Therefore, thermal decomposition of the organic compound can be caused reliably and carbon contained therein can be removed more than required.

According to the manufacturing method of a permanent magnet of the present invention, in the step of calcining the magnet powder, the magnet powder is held for predetermined length of time within a temperature range between 200 and 900 degrees Celsius. Therefore, thermal decomposition of the organic compound can be caused reliably and carbon contained therein can be removed more than required.

### BRIEF DESCRIPTION OF THE DRAWINGS

FIG. 1 is an overall view of a permanent magnet directed to the invention.

FIG. 2 is an enlarged schematic view in vicinity of grain boundaries of the permanent magnet directed to the invention.

FIG. 3 is an explanatory diagram illustrating manufacturing processes of a permanent magnet according to a first manufacturing method of the invention.

FIG. 4 is an explanatory diagram illustrating manufacturing processes of a permanent magnet according to a second manufacturing method of the invention.

FIG. 5 is a diagram illustrating changes of oxygen content with and without a calcination process in hydrogen.

FIG. 6 is a table illustrating residual carbon content in permanent magnets of an embodiment and comparative examples.

### BEST MODE FOR CARRYING OUT THE INVENTION

Specific embodiment of a permanent magnet and a method for manufacturing the permanent magnet according to the present invention will be described below in detail with reference to the drawings.

### [Constitution of Permanent Magnet]

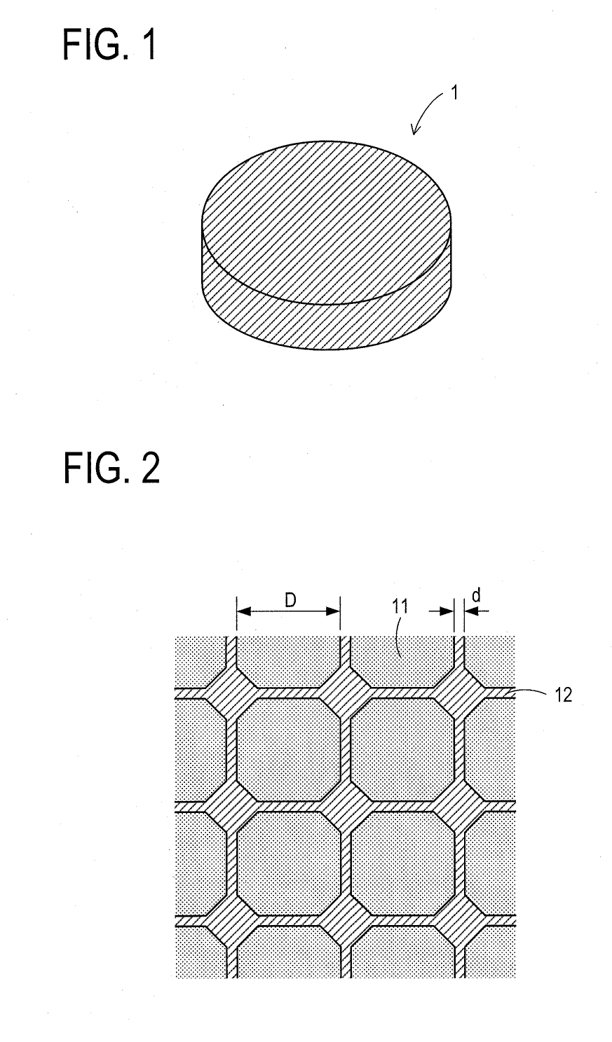

First, a constitution of a permanent magnet 1 will be described. FIG. 1 is an overall view of the permanent magnet directed to the present invention. Incidentally, the permanent magnet 1 depicted in FIG. 1 is formed into a cylindrical shape. However, the shape of the permanent magnet 1 may be changed in accordance with the shape of a cavity used for formation.

As the permanent magnet 1 according to the present invention, an Nd—Fe—B-based magnet may be used, for example. Further, as illustrated in FIG. 2, the permanent magnet 1 is an alloy in which a main phase 11 and an Nd-rich phase 12 coexist. The main phase 11 is a magnetic phase which contributes to the magnetization and the Nd-rich phase 12 is a low-melting-point and non-magnetic phase where rare earth elements are concentrated. FIG. 2 is an enlarged view of Nd magnet particles composing the permanent magnet 1.

Here, in the main phase 11, Nd₂Fe₁₄B intermetallic compound phase (Fe here may be partially replaced with Co), which is of a stoichiometric composition, accounts for high proportion in volume. Meanwhile, the Nd-rich phase 12 consists of an intermetallic compound phase having higher composition ratio of Nd than that of Nd₂Fe₁₄B (Fe here may be partially replaced with Co) of a stoichiometric composition, too (for example, Nd_{2.0-3.0}Fe₁₄B intermetallic compound phase). Further, the Nd-rich phase 12 may include a small amount of other elements such as Dy, Tb, Co, Cu, Al, or Si for improving magnetic property.

Then, in the permanent magnet 1, the Nd-rich phase 12 has the following features. The Nd-rich phase 12:

(1) has a low melting point (approx. 600 degrees Celsius) and turns into a liquid phase at sintering, contributing to densification of the magnet, which means improvement in magnetization;
(2) can eliminate surface irregularity of grain boundaries, decreasing nucleation sites of reverse magnetic domain and enhancing coercive force; and
(3) can magnetically insulate the main phase, increasing the coercive force.

Poorly dispersed Nd-rich phase 12 in the sintered permanent magnet 1 potentially causes a partial sintering defect and degradation in the magnetic property; therefore it is important to have the Nd-rich phase 12 uniformly dispersed in the sintered permanent magnet 1.

An example of problems likely to rise when manufacturing the Nd—Fe—B-based magnet is formation of alpha iron in a sintered alloy. This may be caused as follows: when a permanent magnet is manufactured using a magnet raw material alloy whose contents are based on the stoichiometric composition, rare earth elements therein combine with oxygen during the manufacturing process so that the amount of rare earth elements becomes insufficient in comparison with the stoichiometric composition. Here, the alpha iron has a deformability and remains in a milling device without being milled, and accordingly, the alpha iron not only deteriorates the efficiency in milling the alloy, but also adversely affects the grain size distribution and composition variation before and after milling. Further, if alpha iron remains in the magnet after sintering, the magnetic property of the magnet is degraded.

It is thus desirable that the amount of all rare earth elements contained in the permanent magnet 1, including Nd, is within a range of 0.1 wt % through 10.0 wt % larger, or more preferably, 0.1 wt % through 5.0 wt % larger than the amount based upon the stoichiometric composition (26.7 wt %). Specifically, the contents of constituent elements are set as Nd: 25 through 37 wt %, B: 0.8 through 2 wt %, Fe (electrolytic iron): 60 through 75 wt %, respectively. By setting the contents of rare earth elements in the permanent magnet within the above range, it becomes possible to obtain the sintered permanent magnet 1 in which the Nd-rich phase 12 is uniformly dispersed. Further, even if the rare earth elements are combined with oxygen during the manufacturing process, the formation of alpha iron in the sintered permanent magnet 1 can be prevented, without shortage of the rare earth elements in comparison with the stoichiometric composition.

Incidentally, if the amount of rare earth elements contained in the permanent magnet 1 is smaller than the above-described range, the Nd-rich phase 12 becomes difficult to be formed. Also, the formation of alpha iron cannot sufficiently be inhibited. Meanwhile, if the content of rare earth elements in the permanent magnet 1 is larger than the above-described range, the increase of the coercive force becomes slow and also the residual magnetic flux density is reduced. Therefore such a case is impractical.

Furthermore, in the present invention, wet milling is performed in which magnet raw material put into the organic solvent is milled in the organic solvent, when the magnet material is milled into magnet powder of a very fine particle size. However, in a case where the magnet material is milled wet in the organic solvent, an organic compound such as the organic solvent remains in the magnet, even if the organic solvent is volatilized through vacuum desiccation performed later. In addition, reactivity of Nd and carbon is significantly high so that carbide may be created in case carbon-containing material remains even at a high-temperature stage in a sintering process. As a result, there is a problem that gaps are formed between the main phase and the grain boundary phase (Nd-rich phase) of the magnet after sintering due to the created carbide, making it impossible to densely sinter the entirety of the magnet, and thus significantly deteriorating the magnetic properties thereof. However, in the present invention, the carbon content in magnet particles can be reduced in advance through performing a later-described calcination process in hydrogen before sintering.

Further, it is desirable to set the crystal grain diameter of the main phase 11 to be 0.1 μm through 5.0 μm. Incidentally, the structure of the main phase 11 and the Nd-rich phase 12 can be confirmed, for instance, through scanning electron microscopy (SEM), transmission electron microscopy (TEM) or three-dimensional atom probe technique.

If Dy or Tb is included in the Nd-rich phase 12, coercive force can be improved by Dy or Tb inhibiting formation of the reverse magnetic domain in the grain boundaries.

### [First Method for Manufacturing Permanent Magnet]

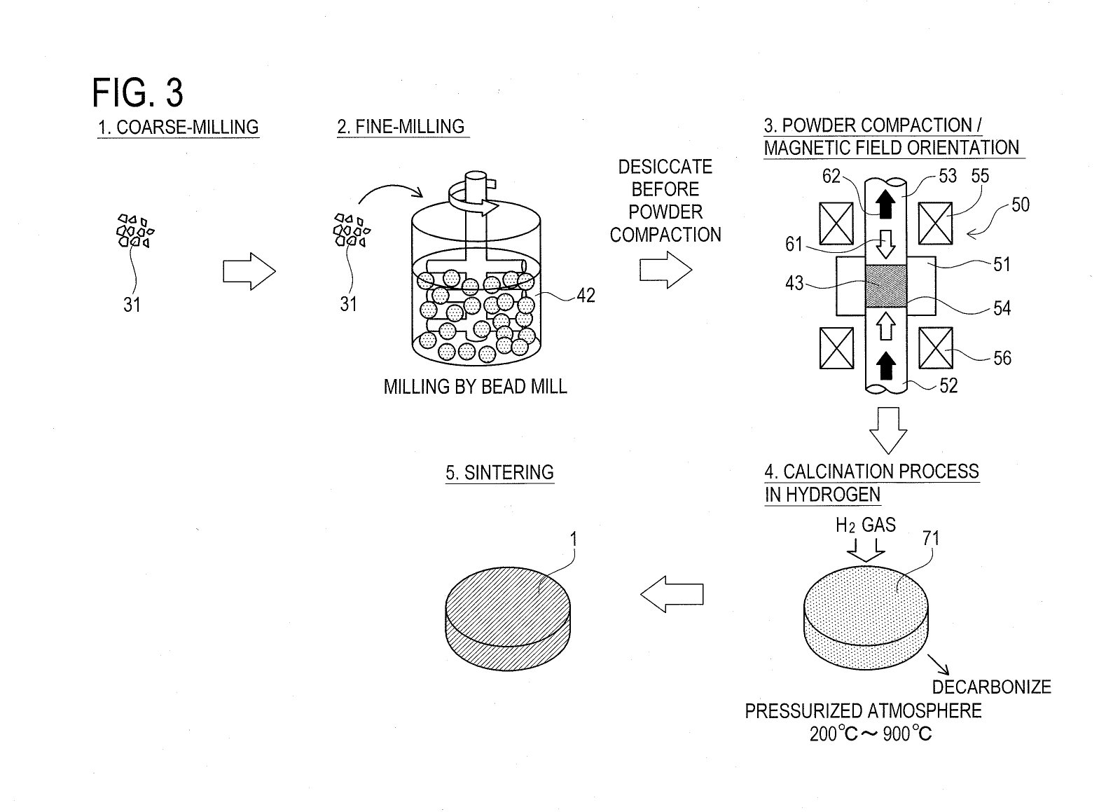

Next, the first method for manufacturing the permanent magnet 1 directed to the present invention will be described below with reference to FIG. 3. FIG. 3 is an explanatory view illustrating a manufacturing process in the first method for manufacturing the permanent magnet 1 directed to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is melted, formed into flakes using a strip-casting process, and then coarsely milled using a hydrogen pulverization method. Thus, coarsely-milled magnet powder 31 is obtained.

Then, the coarsely milled magnet powder 31 is finely milled to a predetermined size (for instance, 0.1 μm-5.0 μm) by a wet method using a bead mill, and the magnet powder is dispersed in a solvent to prepare slurry 42. Incidentally, in the wet milling, 4 kg of toluene is used as a solvent to 0.5 kg of the magnet powder.

Incidentally, the detail of dispersion conditions is as follows:
Dispersing device: bead mill; and
Dispersing media: zirconia beads.

Furthermore, the solvent used for milling is an organic solvent. However, there is no particular limitation on the types of solvent, and there can be used an alcohol such as isopropyl alcohol, ethanol or methanol, an ester such as ethyl acetate, a lower hydrocarbon such as pentane or hexane, an aromatic compound such as benzene, toluene or xylene, a ketone, a mixture thereof or the like. However, it is preferable to use a hydrocarbon-based solvent containing no oxygen atoms therein.

Thereafter, the prepared slurry 42 is desiccated in advance through vacuum desiccation or the like before formed into a shape and desiccated magnet powder 43 is obtained. Then, the desiccated magnet powder is subjected to powder compaction to form a given shape using a compaction device 50. There are dry and wet methods for the powder compaction here, and the dry method involves filling a cavity with the desiccated fine powder and the wet method involves filling a cavity with the slurry 42 without desiccation. In this embodiment, a case where the dry method is used is described as an example. Furthermore, the organic solvent can be volatilized at the sintering stage after compaction.

As illustrated in FIG. 3, the compaction device 50 has a cylindrical mold 51, a lower punch 52 and an upper punch 53, and a space surrounded therewith forms a cavity 54. The lower punch 52 slides upward/downward with respect to the mold 51, and the upper punch 53 slides upward/downward with respect to the mold 51, in a similar manner.

In the compaction device 50, a pair of magnetic field generating coils 55 and 56 is disposed in the upper and lower positions of the cavity 54 so as to apply magnetic flux to the magnet powder 43 filling the cavity 54. The magnetic field to be applied may be, for instance, 1 MA/m.

When performing the powder compaction, firstly, the cavity 54 is filled with the desiccated magnet powder 43. Thereafter, the lower punch 52 and the upper punch 53 are activated to apply pressure against the magnet powder 43 filling the cavity 54 in a pressure direction of arrow 61, thereby performing compaction thereof. Furthermore, simultaneously with the pressurization, pulsed magnetic field is applied to the magnet powder 43 filling the cavity 54, using the magnetic field generating coils 55 and 56, in a direction of arrow 62 which is parallel with the pressure direction. As a result, the magnetic field is oriented in a desired direction. Incidentally, it is necessary to determine the direction in which the magnetic field is oriented while taking into consideration the magnetic field orientation required for the permanent magnet 1 formed from the magnet powder 43.

Furthermore, if the wet method is used, slurry may be injected while applying the magnetic field to the cavity 54, and in the course of the injection or after termination of the injection, a magnetic field stronger than the initial magnetic field may be applied while performing the wet molding. Furthermore, the magnetic field generating coils 55 and 56 may be disposed such that the application direction of the magnetic field is perpendicular to the pressure direction.

Furthermore, instead of the above-discussed powder compaction, green sheet molding may be employed to produce a formed body. There are several methods, for instance, for producing a formed body by the green sheet molding as shown below. The first method is as follows: mixing milled magnet powder, organic solvent and a binder resin, to obtain slurry, and coating a surface of a base with the slurry at a predetermined thickness using a coating method such as a doctor blade system, die casting or a comma coating system, to form a green sheet. The second method is as follows: mixing the magnet powder and the binder resin to obtain a powdery mixture, and, depositing the heated and melted powdery mixture onto a base to form a green sheet. In a case of using the first method for producing the green sheet, magnetic field is applied before the slurry on the base dries, for magnetic field orientation of the green sheet. Meanwhile, in a case of employing the second method for producing the green sheet, the once produced green sheet is heated and magnetic field is applied to the heated green sheet, for magnetic field orientation.

Secondly, the formed body 71 produced through the powder compaction is held for several hours (for instance, five hours) at 200 through 900 degrees Celsius, or more preferably 400 through 900 degrees Celsius (for instance, 600 degrees Celsius) in hydrogen atmosphere at a pressure higher than normal atmospheric pressure (for instance, 0.5 MPa or 1.0 MPa), to perform a calcination process in hydrogen. The hydrogen feed rate during the calcination is 5 L/min. So-called decarbonization is performed during this calcination process in hydrogen. In the decarbonization, the organic compound is thermally decomposed so that carbon content in the calcined body can be decreased. Furthermore, calcination process in hydrogen is to be performed under a condition that makes carbon content in the calcined body 1000 ppm or lower, or more preferably 400 ppm or lower. Accordingly, it becomes possible to densely sinter the permanent magnet 1 as a whole in the later sintering process, and the decrease in the residual magnetic flux density and coercive force can be prevented.

Here, NdH₃ exists in the formed body 71 calcined through the calcination process in hydrogen as above described, and this indicates a problematic tendency to combine with oxygen. However, in the first manufacturing method, the formed body 71 after the calcination is brought to the later-described sintering without being exposed to the external air, eliminating the need for the dehydrogenation process. The hydrogen contained in the formed body is removed while being sintered. As pressurization condition for above-described calcination process in hydrogen, a pressure higher than normal atmospheric pressure is optimal; however, 15 MPa or lower is desirable.

Following the above, there is performed a sintering process for sintering the formed body 71 calcined through the calcination process in hydrogen. However, for a sintering method for the formed body 71, there can be employed, besides commonly-used vacuum sintering, pressure sintering in which the formed body 71 is sintered in a pressured state. For instance, when the sintering is performed in the vacuum sintering, the temperature is raised to approximately 800 through 1080 degrees Celsius in a given rate of temperature increase and held for approximately two hours. During this period, the vacuum sintering is performed, and as to the degree of vacuum, the pressure is preferably equal to or lower than 5 Pa, or more preferably equal to or lower than 10⁻² Pa. The formed body 71 is then cooled down, and again undergoes a heat treatment in 600 through 1000 degrees Celsius for two hours. As a result of the sintering, the permanent magnet 1 is manufactured. Meanwhile, the pressure sintering includes, for instance, hot pressing, hot isostatic pressing (HIP), high pressure synthesis, gas pressure sintering, and spark plasma sintering (SPS) and the like. However, it is preferable to adopt the spark plasma sintering, so as to prevent grain growth of the magnet particles during the sintering and also to prevent a warp from occurring in the sintered magnets. The spark plasma sintering is uniaxial pressure sintering in which pressure is uniaxially applied and also in which sintering is performed by electric current sintering. Incidentally, the following are the preferable conditions when the sintering is performed in the SPS; pressure is applied at 30 MPa, the temperature is raised at a rate of 10 degrees Celsius per minute until reaching 940 degrees Celsius in vacuum atmosphere of several Pa or less and then the state of 940 degrees Celsius in vacuum atmosphere is held for approximately five minutes. The formed body 71 is then cooled down, and again undergoes a heat treatment in 600 through 1000 degrees Celsius for two hours. As a result of the sintering, the permanent magnet 1 is manufactured.

### [Second Method for Manufacturing Permanent Magnet]

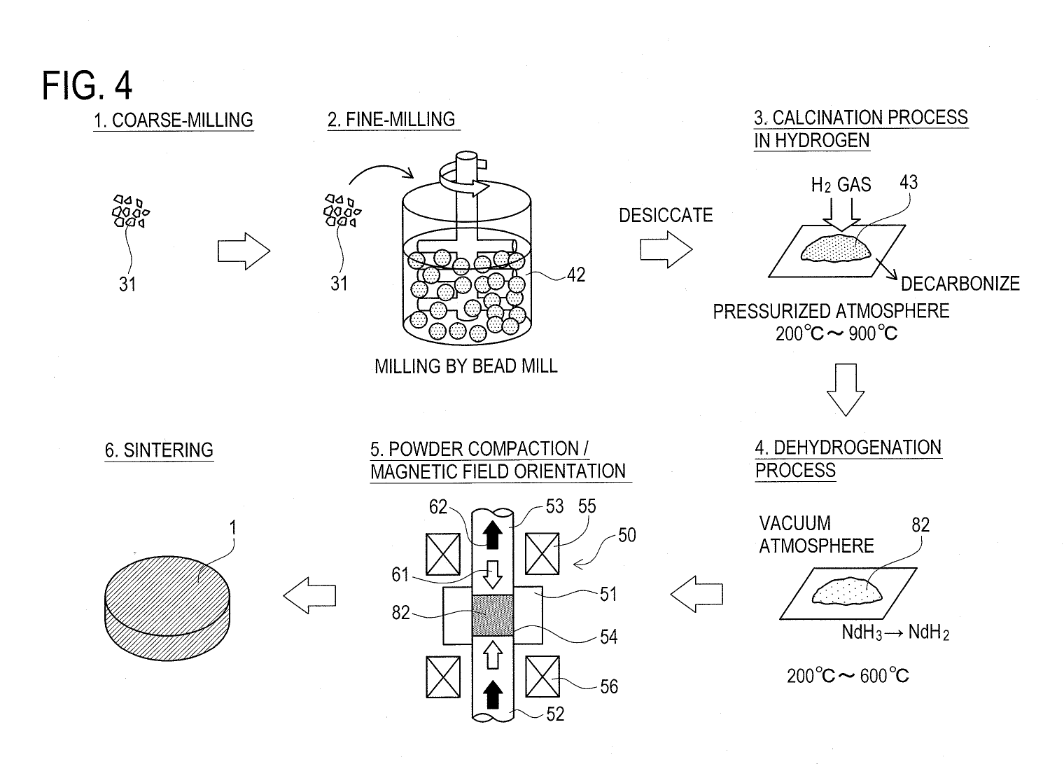

Next, the second method for manufacturing the permanent magnet 1 which is an alternative manufacturing method will be described below with reference to FIG. 4. FIG. 4 is an explanatory view illustrating a manufacturing process in the second method for manufacturing the permanent magnet 1 directed to the present invention.

The process until the slurry 42 is manufactured is the same as the manufacturing process in the first manufacturing method already discussed referring to FIG. 3, therefore detailed explanation thereof is omitted.

Firstly, the prepared slurry 42 is desiccated in advance through vacuum desiccation or the like before formed into a shape, and desiccated magnet powder 43 is obtained. Then, the desiccated magnet powder 43 is held for several hours (for instance, five hours) at 200 through 900 degrees Celsius, or more preferably 400 through 900 degrees Celsius (for instance, 600 degrees Celsius) in hydrogen atmosphere at a pressure higher than normal atmospheric pressure (for instance, 0.5 MPa or 1.0 MPa), for a calcination process in hydrogen. The hydrogen feed rate during the calcination is 5 L/min. Decarbonization is performed in this calcination process in hydrogen. In the decarbonization, the organic compound is thermally decomposed so that carbon content in the calcined powder can be decreased. Furthermore, calcination process in hydrogen is to be performed under a condition that makes carbon content in the calcined powder 1000 ppm or lower, or more preferably 400 ppm or lower. Accordingly, it becomes possible to densely sinter the permanent magnet 1 as a whole in the later sintering process, and the decrease in the residual magnetic flux density and coercive force can be prevented.

Secondly, the calcined powder 82 in a powdery state calcined through the calcination process in hydrogen is held for one through three hours in vacuum atmosphere at 200 through 600 degrees Celsius, or more preferably 400 through 600 degrees Celsius for a dehydrogenation process. Incidentally, as to the degree of vacuum, the pressure is preferably equal to or lower than 0.1 Torr.

Here, NdH₃ exists in the calcined powder 82 calcined through the calcination process in hydrogen as above described, which indicates a problematic tendency to combine with oxygen.

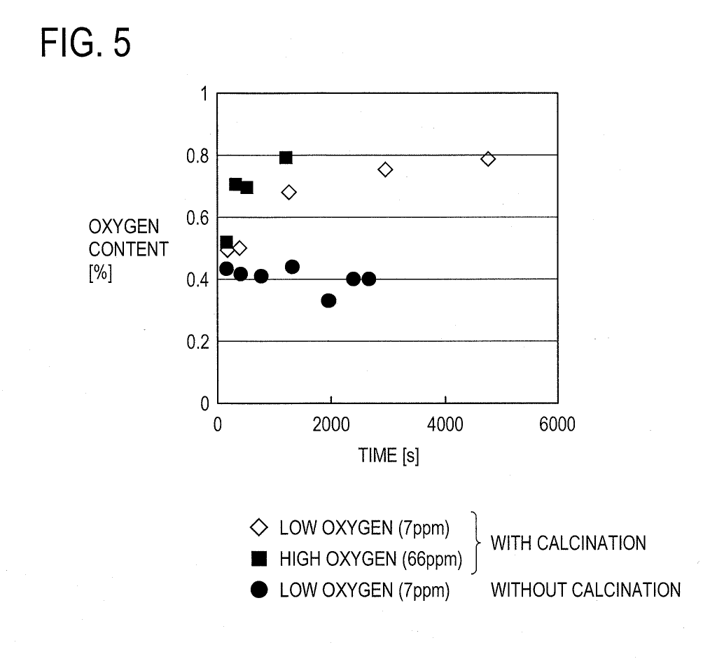

FIG. 5 is a diagram depicting oxygen content of magnet powder with respect to exposure duration, when Nd magnet powder with a calcination process in hydrogen and Nd magnet powder without a calcination process in hydrogen are exposed to each of the atmosphere with oxygen concentration of 7 ppm and the atmosphere with oxygen concentration of 66 ppm. As illustrated in FIG. 5, when the Nd magnet powder with the calcination process in hydrogen is exposed to the atmosphere with high-oxygen concentration of 66 ppm, the oxygen content of the magnet powder increases from 0.4% to 0.8% in approximately 1000 sec. Even when the Nd magnet powder with the calcination process is exposed to the atmosphere with low-oxygen concentration of 7 ppm, the oxygen content of the magnet powder still increases from 0.4% to the similar amount 0.8%, in approximately 5000 sec. Oxygen combined with Nd causes the decrease in the residual magnetic flux density and in the coercive force.

Therefore, in the above dehydrogenation process, NdH₃ (having high reactivity level) in the calcined powder 82 created at the calcination process in hydrogen is gradually changed: from NdH₃ (having high reactivity level) to NdH₂ (having low reactivity level). As a result, the reactivity level is decreased with respect to the calcined powder 82 activated by the calcination process in hydrogen. Accordingly, if the calcined powder 82 calcined at the calcination process in hydrogen is later moved into the external air, Nd therein are prevented from combining with oxygen, and the decrease in the residual magnetic flux density and coercive force can also be prevented.

Then, the calcined powder 82 in a powdery state after the dehydrogenation process undergoes the powder compaction to be compressed into a given shape using the compaction device 50. Details are omitted with respect to the compaction device 50 because the manufacturing process here is similar to that of the first manufacturing method already described referring to FIG. 3.

Then, there is performed a sintering process for sintering the formed-state calcined powder 82. The sintering process is performed by the vacuum sintering or the pressure sintering similar to the above first manufacturing method. Details of the sintering condition are omitted because the manufacturing process here is similar to that of the first manufacturing method already described. As a result of the sintering, the permanent magnet 1 is manufactured.

However, the second manufacturing method discussed above has an advantage that the calcination process in hydrogen is performed to the powdery magnet particles, therefore the thermal decomposition of the remaining organic compound can be more easily caused to the whole magnet particles, in comparison with the first manufacturing method in which the calcination process in hydrogen is performed to the magnet particles of the formed state. That is, it becomes possible to securely decrease the carbon content of the calcined powder, in comparison with the first manufacturing method.

However, in the first manufacturing method, the formed body 71 after calcined in hydrogen is brought to the sintering without being exposed to the external air, eliminating a need for a dehydrogenation process. Accordingly, the manufacturing process can be simplified in comparison with the second manufacturing method. However, also in the second manufacturing method, in a case where the sintering is performed without any exposure to the external air after calcined in hydrogen, the dehydrogenation process becomes unnecessary.

### Embodiment

Here will be described an embodiment according to the present invention referring to comparative examples for comparison.

### Embodiment 1

In comparison with a fraction regarding alloy composition of a neodymium magnet according to the stoichiometric composition (Nd: 26.7 wt %, Fe (electrolytic iron): 72.3 wt %, B: 1.0 wt %), proportion of Nd in that of the neodymium magnet powder for the embodiment 1 is set higher, such as Nd/Fe/B=32.7/65.96/1.34 in wt %, for instance. Further, toluene is used as organic solvent for wet milling. A calcination process has been performed by holding the magnet powder before forming into a shape for five hours at 600 degrees Celsius in hydrogen atmosphere at 0.5 MPa being a pressure higher than normal atmospheric pressure (in this embodiment, the normal atmospheric pressure at manufacturing is assumed to be standard atmospheric pressure (approx. 0.1 MPa)). The hydrogen feed rate during the calcination is 5 L/min. Sintering of the formed-state calcined powder has been performed in vacuum atmosphere. Other processes are the same as the processes in [Second Method for Manufacturing Permanent Magnet] mentioned above.

### Comparative Example 1

Toluene is used as organic solvent for wet milling. The calcination process in hydrogen has been performed under hydrogen atmosphere of normal atmospheric pressure (0.1 MPa). Sintering of the formed-state magnet powder has been performed in vacuum atmosphere. Other conditions are the same as the conditions in embodiment 1.

### Comparative Example 2

Toluene is used as organic solvent for wet milling. The magnet powder after wet-milling is formed into a shape without the calcination process in hydrogen. Sintering of the formed-state magnet powder has been performed in vacuum atmosphere. Other conditions are the same as the conditions in embodiment 1.

(Comparison of Embodiment with Comparative Examples Regarding Residual Carbon Content)

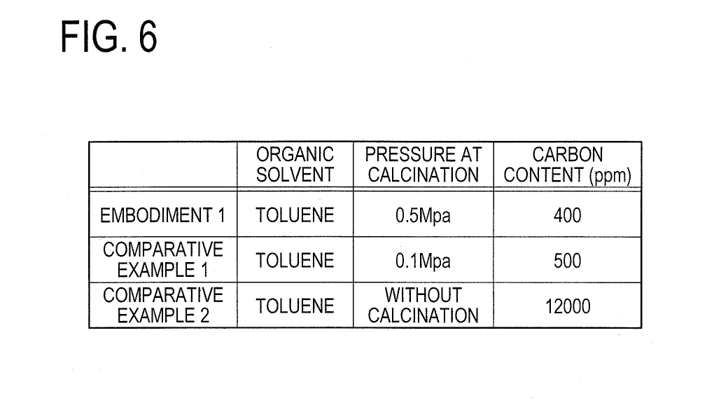

The table of FIG. 6 shows residual carbon content [ppm] in each permanent magnet according to the embodiment 1 and the comparative examples 1 and 2, respectively.

As shown in FIG. 6, comparison of embodiment 1 with comparative examples 1 and 2 shows that the carbon content remaining in the magnet particles can be made significantly smaller when the calcination process in hydrogen has been performed, than in the case without the calcination process in hydrogen. Specifically in embodiment 1, the carbon content remaining in the magnet particles can be made 400 ppm or lower. This demonstrates that the calcination process in hydrogen enables the decarbonization in which carbon content in the calcined powder can be decreased through thermally decomposing the organic compound. As a result of that, it becomes possible to densely sinter the entirety of the magnet and to prevent deterioration of the coercive force.

Further, as it is apparent from a comparison between the embodiment 1 and the comparative example 1, despite addition of the same organic compound, the case with the calcination process in hydrogen at a pressure higher than normal atmospheric pressure can reduce carbon content more significantly than the case at normal atmospheric pressure. In other words, through the calcination process in hydrogen, there can be performed the decarbonization, in which the organic compound is thermally decomposed so that carbon content in the calcined powder can be decreased, and also, the calcination process in hydrogen at a pressure higher than normal atmospheric pressure can facilitate easier decarbonization. As a result, it becomes possible to densely sinter the entirety of the magnet and to prevent the coercive force from declining.

In the above embodiment 1 and comparative examples and 2, permanent magnets manufactured basically in accordance with [Second Method for Manufacturing Permanent Magnet] have been used. Similar results can be obtained in case of using permanent magnets manufactured basically in accordance with [First Method for Manufacturing Permanent Magnet].

As described in the above, with respect to the permanent magnet 1 and the manufacturing method of the permanent magnet 1 directed to the above embodiment, coarsely-milled magnet powder is further milled in a solvent by a bead mill. Thereafter, a formed body produced through powder compaction of the magnet powder is held for several hours in hydrogen atmosphere at a pressure higher than normal atmospheric pressure at 200 through 900 degrees Celsius for a calcination process in hydrogen. Thereafter, through sintering at 800 through 1180 degrees Celsius, the permanent magnet 1 is manufactured. Accordingly, even if an organic solvent is used in wet-milling of the magnet material, the remaining organic compound can be thermally decomposed and carbon contained in the magnet particles can be removed before sintering (i.e., carbon content can be reduced). Therefore, almost no carbide is formed in a sintering process. Consequently, the entirety of the magnet can be sintered densely without making a gap between a main phase and a grain boundary phase in the sintered magnet and decline of coercive force can be avoided. Further, considerable alpha iron does not separate out in the main phase of the sintered magnet and serious deterioration of magnetic properties can be avoided.

Still further, in the process of calcining the magnet powder or the formed body, the formed body is held for a predetermined length of time within a temperature range between 200 and 900 degrees Celsius, more preferably, between 400 and 900 degrees Celsius. Therefore, carbon contained in the magnet particles can be removed more than required.

As a result, carbon content remaining after sintering becomes 400 ppm or lower. Thereby, the entirety of the magnet can be sintered densely without occurrence of a gap between a main phase and a grain boundary phase and decline in residual magnetic flux density can be avoided.

In the second manufacturing method, calcination process is performed to the powdery magnet particles, therefore the thermal decomposition of the remaining organic compound can be more easily performed to the entirety of the magnet particles in comparison with a case of calcining a formed body of magnet particles. That is, it becomes possible to reliably decrease the carbon content of the calcined powder. By performing dehydrogenation process after calcination process, activity level is decreased with respect to the calcined powder activated by the calcination process. Thereby, the resultant magnet particles are prevented from combining with oxygen and the decrease in the residual magnetic flux density and coercive force can also be prevented.

It is to be understood that the present invention is not limited to the above-described embodiment but may be variously improved and modified without departing from the scope of the present invention.

Further, of magnet powder, milling condition, mixing condition, calcination condition, dehydrogenation condition, sintering condition, etc. are not restricted to conditions described in the embodiment. For instance, in the above embodiment, the calcination process is performed under hydrogen atmosphere pressurized to 0.5 MPa; however, the pressure can be set at a different value as long as it is higher than normal atmospheric pressure. Further, in the embodiment, sintering is performed by vacuum sintering. However, pressure sintering such as SPS may be employed.

Further, the dehydrogenation process may be omitted. Incidentally, in the embodiment, a wet bead mill is used as a means for wet-milling the magnet powder; however, other wet-milling methods may be used. For instance, Nanomizer (trade name of a wet-type media-less atomization device manufactured by Nanomizer, Inc.) may be used.

### EXPLANATION OF REFERENCES

1 permanent magnet
11 main phase
12 Nd-rich phase
42 slurry
43 magnet powder
71 formed body
82 calcined powder

1-5. (canceled)

6. A manufacturing method of a permanent magnet comprising steps of:
wet-milling magnet material in an organic solvent to obtain magnet powder;
forming the magnet powder into a formed body;
calcining the formed body in hydrogen atmosphere at a pressure higher than normal atmospheric pressure so as to obtain a calcined body; and
sintering the calcined body.

7. A manufacturing method of a permanent magnet comprising steps of:
wet-milling magnet material in an organic solvent to obtain magnet powder;
calcining the magnet powder in hydrogen atmosphere at a pressure higher than normal atmospheric pressure so as to obtain calcined powder;
forming the calcined powder into a formed body; and
sintering the formed body.

8. The manufacturing method of a permanent magnet according to claim 6, wherein, in the step of calcining the magnet powder, the magnet powder is held for predetermined length of time within a temperature range between 200 and 900 degrees Celsius.

9. The manufacturing method of a permanent magnet according to claim 7, wherein, in the step of calcining the magnet powder, the magnet powder is held for predetermined length of time within a temperature range between 200 and 900 degrees Celsius.

10. The manufacturing method of a permanent magnet according to claim 6, wherein residual carbon content of the calcined body after sintering is 400 ppm or lower.

11. The manufacturing method of a permanent magnet according to claim 7, wherein residual carbon content of the formed body after sintering is 400 ppm or lower.
